(19) United States
(12) Patent Application Publication
(10) Pub. No.: US 2009/0314491 A1
(43) Pub. Date: Dec. 24, 2009

(54) MOTION DETECTOR

(75) Inventors: Sven Revheim, Hafersfjord (NO); Espen Revheim, Tananger (NO)

Correspondence Address: BIRCH STEWART KOLASCH & BIRCH, PO BOX 747, FALLS CHURCH, VA, 22040-0747, US

(73) Assignee: Seawell Oil Tools AS, Stavanger (NO)

(21) Appl. No.: 12/522,349

(22) PCT Filed: Jan. 8, 2008
(86) PCT No.: PCT/NO2008/000005

§ 371 Date: Aug. 27, 2009

(30) Foreign Application Priority Data
Jan. 8, 2007 (NO) 20070143

(51) Int. Cl. E21B 47/09; G01B 7/14

(52) U.S. Cl. 166/255.1; 324/207.11

(57) ABSTRACT

A method and an apparatus for activating an event if an object has undergone a pattern of motion with alternating motion and standstill which corresponds to a predetermined sequence of motions, in which all forms of motion are included.

### INTRODUCTION

The present invention relates to a magnetic field detector for detection of motion or standstill. More specifically, the invention relates to a method and an apparatus for detection of a specific sequence of motions that initiates activation of an event.

### PRIOR ART

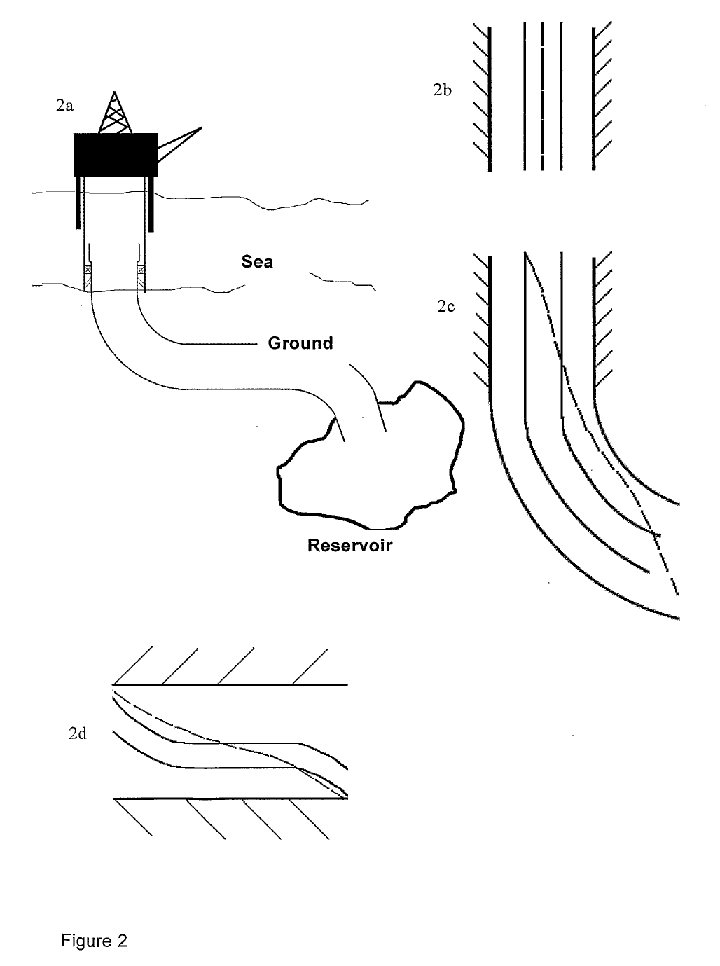

Motion detection in oil and gas wells has proven to be difficult. When running different tools into the well, it is important to receive feedback as to whether the tool responds to various activation signals that are sent to the tool. As a consequence of large well depths, it may be difficult to know whether a tool is doing what it is supposed to do. It may take a long time before motion or standstill of a tool can be determined at the surface. Traditionally, it has simply been established whether a tool is moving by observing the motion of a string, such as a drill string, coiled tubing or the like at the surface. This works nicely if the well is not too deep, and also provided that a string is in fact used, such as a drill string, coiled tubing or the like. As deeper wells have been drilled, it has been desirable to use to a greater extent, tools which do not hang down from said string, such as a drill string, coiled tubing or the like because the long connections involve greater costs, are more subject to failure in the form of cable breaks etc., and take a long time to run up and down in the well. At great depths, the traditional way of detecting motion or standstill is thus inadequate. The string, drill string, coiled tubing or the like can be moved relatively far on the surface without it being possible to determine unequivocally whether the tool is actually moving in the well, because the connection between the tool and the surface may expand or be compressed quite substantially without the tool far down in the well moving. This is shown in FIGS. 2a-d. The broken line indicates the drill string under tension. The difference between the broken line and the solid line indicates slack that must be drawn out before motion on the drill floor is detected downhole. FIG. 2a shows slack in a drill string, FIG. 2b shows vertical tension; no slack apart from stretch in the string, FIG. 2c shows angle; delayed motion downhole as motion on the surface helps to draw in slack, FIG. 2d shows horizontal tension; delayed motion downhole as the motion on the surface helps to draw in slack.

The instruments used for motion detection may be arranged on the tool that is run down into the well without their comprising any means of communication, or possibly only comprising means for one-way communication. Such instruments may, for example, be used to prevent other equipment from being activated when a tool is in motion, for one-way communication from the surface to a tool etc.

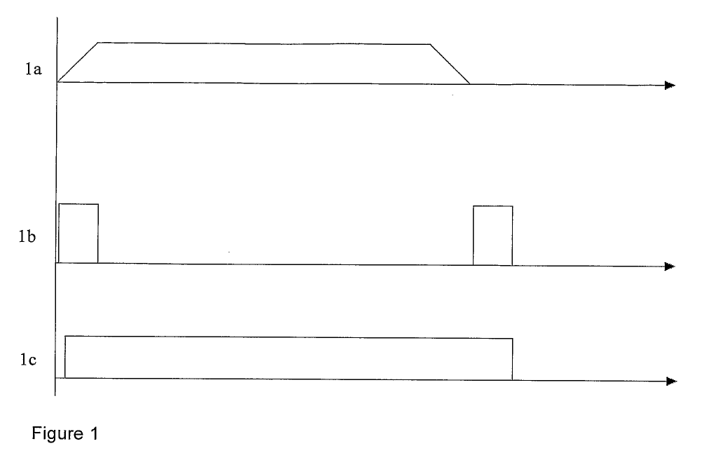

Measuring motion by using one or more accelerometers is a well-known, tried and tested method. An accelerometer measures acceleration, not motion, but as all motion starts and stops with an acceleration, the accelerometer can be used for motion detection. However, the use of accelerometers to detect motion is associated with a number of drawbacks. The accelerometer is inaccurate and requires relatively large and powerful motions in order to provide readings. At great depths, as mentioned, large motions at the surface can be dampened substantially in that the connection expands or is compressed, and the resultant motion of the tool downhole may be so weak and slow that the accelerometer does not give a clear reading. In addition, an accelerometer will not distinguish between a steady motion and standstill, as both these situations are characterised by the absence of acceleration. FIG. 1b shows measurements from an accelerometer. The figure shows no values, but is intended to illustrate how an accelerometer merely registers change of speed, positive or negative, not constant speed.

Measuring motion by using pressure sensors has also been used to determine whether a tool is in motion or is at a standstill. As a tool moves up or down in a well, the fluid column above the tool and the resulting pressure to which the tool is subjected will change. These changes in pressure can be used to determine whether the tool has moved further up or down in the well. This method requires the tool to move a long way in the vertical direction in order to establish clearly what motion has taken place. Motions over smaller distances will not give clear readings on a pressure sensor. In addition, the method is not suitable for detection of motion or standstill in a horizontal direction or rotational motion.

Various forms of wave signal analysis have also been used to detect motion or standstill. A wave signal analysis system as a rule transmits a wave signal, either in the form of light, sound or radio waves, and listens to an echo or a reflection. By measuring the delay, it is possible to determine distance to the object that reflects the wave signal. If this distance changes, it may be concluded that a motion has taken place. By in addition looking at the change in frequency, it is possible to determine the speed of the reflecting object. If the speed is greater than zero, motion has been detected. Wave analysis can be very difficult to implement in environments where there is no homogeneous medium in which the wave signals can travel. In an oil or gas well, the wave signals will have to travel in many different types of media, for example, oil, natural gas, water, oil-based mud, water-based mud, metal, air, etc. Each of these materials will distort and/or reflect the wave signals differently. Although widely used for motion detection in oil and gas wells, wave signal analysis has many and clear limitations. It is costly, complex, time-consuming and gives unreliable measurements.

Different types of magnetic field measurements have been in use for many years and are, in some applications, a well-known, tried and tested technology. The most common application of these measurements is direction finding. In such an application, the earth's magnetic field is used to determine direction. Magnetic field measurements can also be used to detect joints (ref. Patent GB-2422622A), or irregularities (ref. U.S. Pat. No. 6,768,299B2) in, for example, steel pipes. These are common areas of application in the oil and processing industries. Systems have also been developed which are so advanced that they can, for example, determine thread type in joints (ref. U.S. Pat. No. 709,522B2). Detection of joints can also be used to determine position in a well. If a certain number of joints have been detected and the distance between the joints is known, the distance the measuring point has covered can be found.

What is considered to be novel and advantageous about the present invention is the use of magnetic field sensors which measure a surrounding magnetic field to detect motion or standstill of an object over time, and the use this information to activate an event when a predetermined sequence of motions is registered. By “surrounding magnetic field” is meant a magnetic field set up by the surroundings. Stable fields such as the earth's magnetic field, the magnetic field of a casing pipe, the magnetic field of motionless magnetic materials or the magnetic field of ground rock are regarded as stable surrounding fields. The inventive apparatus is composed of an independent unit that can move in any direction in relation to the surroundings, the apparatus being connected to the object whose motion it is desired to detect. The apparatus may also remain stationary to detect motions of the surroundings in relation to the apparatus.

U.S. Pat. No. 7,245,299B2 (PathFinder) is regarded as describing the closest prior art. The document describes a method for communicating with a downhole device in order to be able to send control signals to, for example, a directional drilling tool.

The said document describes a method involving the use of different speeds of rotation or duration of rotation of a drill string. From this a code can be derived that can be interpreted in order to then control, for example, a drilling tool.

The activation of an event based on an interpretable code has features in common with the present invention, but the way in which the code is generated is very different. The use of a magnetic sensor to measure rotational speed is mentioned as one way of determining rotational speed. Another way is, as mentioned, the use of an optical sensor. The essential aspect of the Pathfinder patent is not the sensor itself, but that the rotational motion per se is used to derive control signals. The magnetic fields that are measured are further set up by permanent magnets mounted on a drill string and with a sensor mounted on a sleeve, where the drill string rotates and the sleeve remains stationary. The measurement of rotational speed is therefore dependent on two mechanical parts which move relative to one another, ref. FIG. 2a and the explanation thereof.

This is different from the present invention where magnetic fields for the most part set up by the surroundings are registered, and where the motion detector is composed of just one part that measures motion in relation to the surroundings without any mechanical moving parts. Thus, the detector according to the invention can be used in different ways and not least in different environments.

The PathFinder solution for the detection of rotational speed makes no major demands on the electronics since it is not necessary to detect differences between each rotation, but only over time. Without fixed points for each rotation, i.e., each registered change in magnetic field, as is the case in the present solution, greater demands will be made on the analysis logic that is to process data from a sensor, since larger amounts of data will have to be compared in order, with certainty, to determine a rotational speed and any change thereof.

The use of rotational motion as a signal means will impose a limitation of having to perform the method described in PathFinder during a typical drilling operation in which the drill string rotates. The speed and duration of rotation will then be controlled by operators on the surface.

The present invention is more flexible since it is not limited to rotational motion only, but some form of motion which also includes rotational motion. By distinguishing between motion and non motion, a code can be derived that can be used to activate an event such as controlling a tool. The apparatus that constitutes the invention can thus be used under conditions where a rotational motion cannot be made.

The present invention describes a method and an apparatus that can be used also in operations other than drilling, such as well completion, maintenance and inspection.

If the sleeve with magnet-sensitive elements and the mandrel equipped with magnets become interlocked, it will not be possible to communicate with the tool. The invention is implemented in just one part without any moving components, which will ensure that communication is always possible. There is also no need for contact with casing pipes or rock wall to create friction and thus motion between sleeve and mandrel.

The PathFinder solution requires feedback from the tool downhole up to the surface in order to work in a setting such as drilling, carried out, for example, with mud pulsing. The intelligence controlling the tool is located on the surface, whilst the intelligence in the present solution is located downhole. When an event takes place, the tool will thus know what is to be done.

The apparatus according to the present invention is an independent unit which detects standstill and all types of motion based on registered changes in magnetic fields. The apparatus can thus be used as an activation apparatus when a predetermined sequence of motion is detected. The apparatus further has means for optimising measured magnetic fields. Optimisation may include self-adjusting filters that are adjusted according to the surroundings in which the apparatus operates so as to thereby obtain clearer measurements.

### SUMMARY OF THE INVENTION

The object of the present invention is to provide a method and an apparatus to activate an event by detecting motion or standstill in a simpler, less costly and more accurate manner than the prior art apparatus and methods.

Although the exemplary embodiments are for the most part based on problem complexes related to the detection of motion or standstill in oil and gas wells, it should be understood that the invention is not limited to such areas of use and that the invention can be used in all situations where detection of motion is of interest.

The object of the present invention is achieved with a method that is characterised by the features disclosed in independent claim 1, and by further advantageous embodiments and features as disclosed in the dependent claims.

The invention also comprises an apparatus for carrying out said method.

A detailed description of a number of exemplary embodiments of the present invention is given below with reference to the attached drawings, wherein:

FIG. 1 shows accelerometer versus magnetic field measurements. Difference between measurements from magnetic field sensor and accelerometer. The figure does not show any values, but is intended to illustrate how an accelerometer only registers a change in speed, positive or negative, not constant speed. By “magnetic field measurements” is meant the difference between current and previous measurements.

FIG. 1a shows an example of a sequence of motions of a arbitrary object;

FIG. 1b shows an example of what type of measurement signals an accelerometer will give in the case of the sequence of motions indicated in FIG. 1a; and

FIG. 1c shows an example of what type of measurement signals a magnetic field sensor will give in the case of the sequence of motions indicated in FIG. 1a.

FIG. 2 shows an example of how tension in a drill string will result in a different sequence of motions for a tool that is located far downhole than for the part of the drill string that is on the surface. The broken line indicates the drill string under tension. The difference between the broken line and the solid line indicates slack that must be drawn out before motion on the drill floor is registered downhole.

FIG. 2a shows slack in a drill string;

FIG. 2b shows vertical tension, no slack apart from stretch in the string;

FIG. 2c shows angle, delayed motion downhole as motion on the surface helps to take in slack; and

FIG. 2d shows horizontal tension, delayed motion downhole as the motion on the surface helps to take in slack.

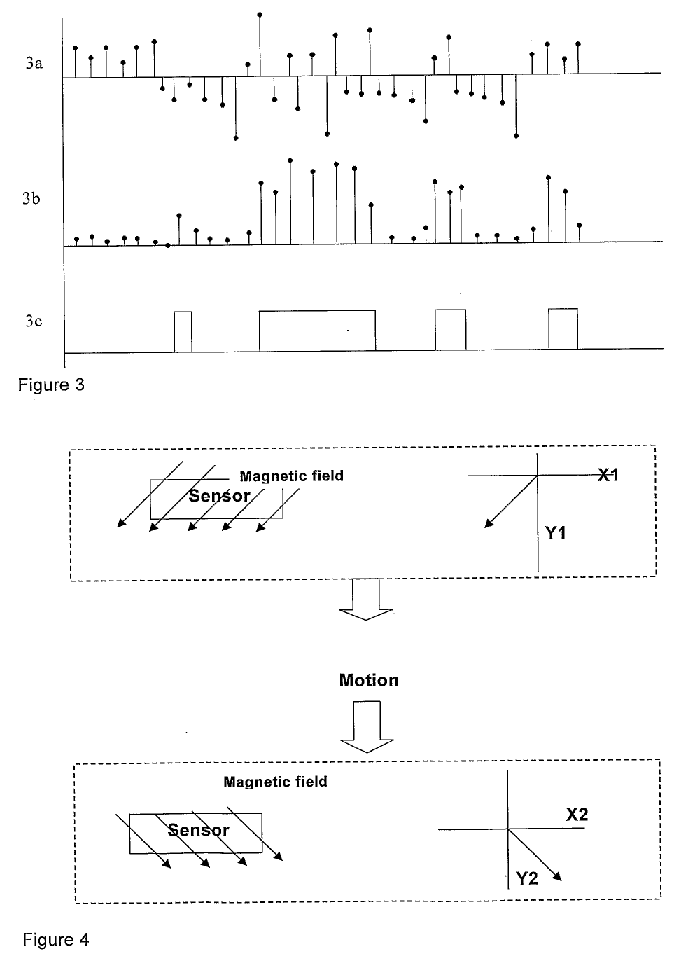

FIG. 3 shows examples of typical 1D-measurements from a magnetic field sensor and the readings that may be obtained after the measurements have been processed. An examination of the values from the magnetic field sensor will not give any indication of whether there is motion. It is not until a comparison with previous values is made that motion will be detected. Clear readings are then obtained when there is motion.

FIG. 3a shows typical values for the signal going into the sensor;

FIG. 3b shows typical values of the absolute value of the difference; and

FIG. 3c shows typical values on detection of motion.

FIG. 4 shows the consequence of motion in a 2-dimensional magnetic field, where the difference in the X direction is given by X1-X2 and the difference in the Y direction is given by Y1-Y2.

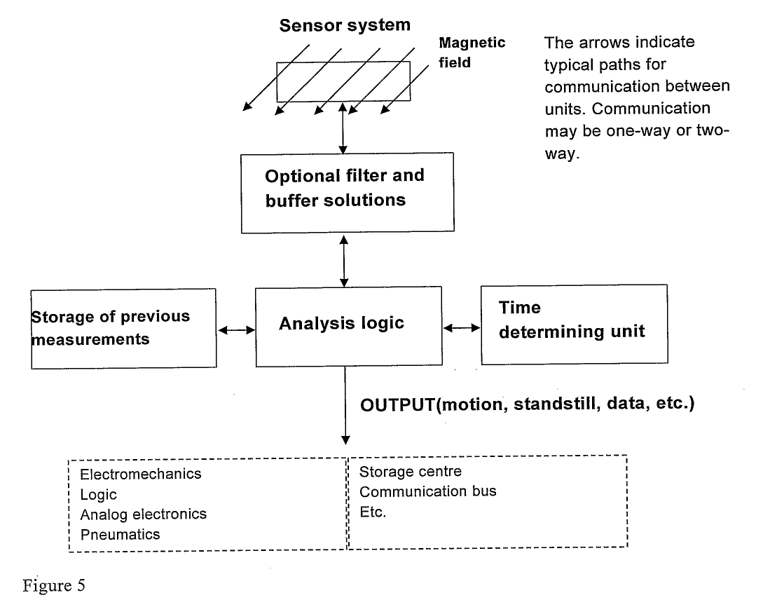

FIG. 5 is a block diagram showing how the whole system may typically be constructed.

### DETAILED DESCRIPTION

According to the present invention, a magnetic field sensor is used to detect motion or standstill by measuring a variation in magnetic field strength and direction. Motion and standstill can also be measured relative to other magnetic fields, where the system including the sensor remains stationary and magnetic fields in the surroundings move. According to the present invention, measurements of a magnetic field are analysed and compared with one or more previous measurements taken at a given time in advance. If there is a configurable difference between current and previous measurements, the system has detected a motion. This is shown in FIGS. 3a-c. By placing a filter on the signal from the measurement, the system can be given a sensitivity and function intended for different surroundings and conditions.

By employing and configuring different filters, the application of the magnetic field detector according to the present invention can be adapted to many different areas of use. To adapt the measurements to the conditions in an oil or gas well, it may be necessary to have filters which, for example, are sensitivity-reducing, comprise buffer solutions and comprise self-calibration.

One or more sensitivity-reducing filters can, according to the invention, be used to remove noise from the surroundings which otherwise would cause erroneous detection. To compensate for lost sensitivity when using sensitivity-reducing filters, a plurality of magnetic field sensors can be used, and the sampling rate can be increased so that an algorithm used to determine whether there is motion or standstill has a several measurements to compare. By “noise” is meant, for example, unstable magnetic fields from the surroundings, remote or close by.

According to the present invention, the magnetic field detector may comprise one or more buffer elements adapted so that errors due to sudden magnetic field changes can be eliminated. By using a previous measurement or several previous measurements, it will be possible to reduce the error rate. A buffer element will also reduce the response time from the system. This can be solved by reducing the interval between each measurement. A buffer solution can also be used to eliminate so-called inert changes in magnetic fields that are due to changes in the surroundings. In such an embodiment, a buffer will be able to handle average values over given time intervals where there is either constant motion or standstill. The values are stored and compared with later or earlier values, changes over time being shown as a difference.

According to one embodiment of the present invention, one or more self-calibration elements can be used in, for example, oil and gas wells which have magnetic fields that vary strongly. The self-calibration elements use the measurements from the magnetic field sensors to set up a magnetic field that is as strong as, but oppositely directed to, the magnetic field set up by the surroundings. By measuring the energy required to set up this field, the strength of the field from the surroundings is measured.

The magnetic field detector according to the present invention provides a compact, robust, reliable and inexpensive system for detecting motion or standstill. The actual magnetic field sensor is per se known and considered a commercially available product. Suitable magnetic field sensors can be selected on the basis of prevailing needs, and optionally adapted to special applications. The combination of one or more magnetic field sensors with one or more sensitivity-reducing filters, a buffer element and one or more self-calibration elements, will result in a magnetic field detector which can easily be arranged on existing equipment and which can easily be configured and optionally reconfigured to suit different applications. The system can, for example, also be combined with memory means that can be used to register the magnetic field and motion profile of the tool, and thus provide a history log for the tool. A log of this kind may also be configured for self-learning, so that the log data together with real time measurements can be used to configure the filters. This could save the operator a great deal of time and work.

The magnetic field detector according to the present invention can also be combined with other methods for detecting motion, standstill, acceleration, pressure etc. so as thereby to increase the degree of information. It should be understood that the magnetic field detector according to the present invention can be provided by combining suitable commercially available elements, and that the magnetic field detector could also comprise other elements, such as power supply, communication means such as transmitter and receiver elements, memory means, electromechanics, pneumatics, hydraulics etc.

According to one embodiment of the present invention, the magnetic field detector comprises a battery and optionally wireless communication means. Such an embodiment will no longer be dependent on the tool on which it is located comprising some form of physical connection with the surface. The magnetic field detector according to this embodiment will be able to operate independent of signals and/or power from the surface, as the optional wireless communication means can allow various forms of signal transmission to or from the surface, for example, transmission of signals to the surface which indicate that the tool is in motion or not, activation signals from the surface, and/or configuration or reconfiguration of the magnetic field detector from the surface.

According to another embodiment of the present invention, the magnetic field detector communicates with the surface through suitable and per se known cable elements, the power supply either being provided by a battery or being supplied through the cable elements.

It should be understood that the magnetic field detector according to the present invention either can constitute a compact, small, integrated circuit, or the different elements can be arranged at different points, for example, so that the motion of a tool downhole can be monitored from the surface and so that a configuration and optional reconfiguration of the magnetic field detector can be effected on the surface. Parts of the magnetic field detector may, for example, consist of a computer on the surface, where an indication of the tool's motion is shown on a screen or by means of suitable display instruments, and where parameters which are relevant for a configuration or optional reconfiguration of the magnetic field detector can be adjusted via a suitable user interface.

As stated, the magnetic field detector according to the present invention may comprise one or more magnetic field sensors. Most magnetic field sensors are 1-dimensional (1D), i.e., that they essentially measure a magnetic field in one direction. If more than one sensor are used, they may be arranged so that they increase the measuring accuracy of the magnetic field detector, i.e., that they are arranged so as to measure a magnetic field in the same direction. Alternatively, the magnetic field sensors can be arranged perpendicular to one another, so as to obtain 2D- or 3D-measurements. According to one preferred embodiment, at least two magnetic field sensors are used that are oriented perpendicular to each other, at least one in an axial direction, and at least one transverse to the axial direction. The magnetic field sensor(s) which is/are oriented in the axial direction will then be able to indicate motion of the tool axially through, for example, a well, the magnetic field sensor(s) oriented transverse to the axial direction then being able to indicate any rotational motion of the tool. It should be understood that other magnetic field sensor configurations are also possible, the application determining what configurations are expedient.

The magnetic field detector according to the present invention can also be used as an operating control per se. Because the magnetic field detector recognises a predetermined sequence of motion, the magnetic field detector will be able to activate an event or an operation downhole in an oil or gas well. The present invention thus provides an alternative to dropping balls down into the well to start or terminate certain operations. Because the magnetic field detector can both recognise sequences of motions and unequivocally determine that the tool on which it is located has been subjected to a sequence of motions and the motions that are required to perform one or more certain events or operations, the magnetic field detector helps to ensure that the performance of the one or more certain events or operations can immediately be verified from the surface. This helps to save valuable time and prevents unnecessary waiting on the surface. If used as an activator, the magnetic field detector according to the present invention will be able to prevent or start activation on motion or standstill. In connection with such application, there may be a wish to use the magnetic field detector together with other instruments, such as pressure sensors, temperature sensors, skirt detectors, electromechanics, memory, etc.

The magnetic field detector according to the present invention can be adapted to other areas of use and conditions by changing previously mentioned filters or using other filters that are adapted to the conditions in which the magnetic field detector is located. The adaptation of the magnetic field detector to the intended area of use can easily be obtained by reconfiguring the sensitivity-reducing filters, the buffer elements and/or the self-calibration elements, the reconfiguration largely being performable on the software level.

1-10. (canceled)

11. A method performed in an apparatus for activating an event by detection of motion or standstill of an object over time by using one or more magnetic field sensors for detecting variations in signals from a surrounding magnetic field, and converting said signals to values representing changes in the magnetic field, the method comprising the steps of:
clocking the detected values;
comparing two or more clocked values;
determining whether the object has undergone a motion by determining whether the difference between two or more clocked values is greater than a predetermined difference, or determining whether the object has not undergone a motion by determining whether the difference between two or more clocked values is not greater than a predetermined difference; and
activating an event if said object has undergone a pattern of motions with motion and standstill which corresponds to a predetermined sequence of motions.

12. A method according to claim 11, wherein activation of said event is not initiated until detection of standstill or motion.

13. A method according to claim 11, further comprising the step of setting up a magnetic field that is equally as strong as, but oppositely directed to the magnetic field produced by the surroundings, the energy required to set up the equally strong but oppositely directed magnetic field being used to indicate the strength of the magnetic field produced by the surroundings.

14. A method according to claim 11, further comprising the step of using one or more sensitivity-reducing filters to eliminate noise from the surroundings.

15. A method according to claim 11, further comprising the step of orienting the magnetic field sensors perpendicular to one another.

16. A method according to claim 11, further comprising the step of orienting the magnetic field sensors in the same directions.

17. A method according to claim 11, further comprising the step of wirelessly communicating with the surroundings.

18. A method according to claim 11, further comprising the step of communicating with the surroundings through suitable cables.

19. A method according to claim 11, wherein the event activated is located in an oil or gas well.

20. An apparatus comprising:
means for activating an event by detection of motion or standstill of an object over time by using one or more magnetic field sensors for detecting signals from a surrounding magnetic field, and converting said the signals detected by the magnetic field sensor(s) to values representing changes in the magnetic field;
means for clocking the detected values;
means for comparing two or more clocked values;
means for determining whether the object has undergone a motion by determining whether the difference between two or more clocked values is greater than a predetermined difference, or determining whether the object has not undergone a motion by determining whether the difference between two or more clocked values is not greater than a predetermined difference; and
means for activating an event if the said object has undergone a pattern of motions with motion and standstill which corresponds to a predetermined sequence of motions.

21. Apparatus according to claim 20, further comprising means for performing a method for activating an event by detection of motion or standstill of an object over time by using one or more magnetic field sensors for detecting variations in signals from a surrounding magnetic field, and converting said signals to values representing changes in the magnetic field, the method comprising the steps of:
clocking the detected values;
comparing two or more clocked values;
determining whether the object has undergone a motion by determining whether the difference between two or more clocked values is greater than a predetermined difference, or determining whether the object has not undergone a motion by determining whether the difference between two or more clocked values is not greater than a predetermined difference; and
activating an event if said object has undergone a pattern of motions with motion and standstill which corresponds to a predetermined sequence of motions.

22. A method according to claim 12, further comprising the step of using one or more sensitivity-reducing filters to eliminate noise from the surroundings.

23. A method according to claim 13, further comprising the step of using one or more sensitivity-reducing filters to eliminate noise from the surroundings.

24. A method according to claim 12, further comprising the step of orienting the magnetic field sensors perpendicular to one another.

25. A method according to claim 13, further comprising the step of orienting the magnetic field sensors perpendicular to one another.

26. A method according to claim 12, further comprising the step of orienting the magnetic field sensors in the same directions.

27. A method according to claim 13, further comprising the step of orienting the magnetic field sensors in the same directions.

28. A method according to claim 12, further comprising the step of wirelessly communicating with the surroundings.

29. A method according to claim 13, further comprising the step of wirelessly communicating with the surroundings.

30. A method according to claim 14, further comprising the step of wirelessly communicating with the surroundings.
